(19) United States
(12) Patent Application Publication
(10) Pub. No.: US 2002/0147123 A1
(43) Pub. Date: Oct. 10, 2002

(54) Catalase as an oxidative stabilizer in solid particles and granules

(76) Inventors: Nathaniel T. Becker, Hillsborough, CA (US); Matthew J. Flynn, Mountain View, CA (US); Mark S. Gebert, Pacifica, CA (US)

Correspondence Address: Genencor International, Inc., 925 Page Mill Road, Palo Alto, CA, 94034-1013, US

(21) Appl. No.: 10/033,086

(22) Filed: Oct. 29, 2001

Related U.S. Application Data
(60) Provisional application No. 60/243,889, filed on Oct. 27, 2000.
(60) Provisional application No. 60/257,069, filed on Dec. 19, 2000.

(51) Int. Cl. C11D 3/386; C11D 7/18

(52) U.S. Cl. 510/305; 510/374; 510/392; 510/530

(57) ABSTRACT

The present invention provides a particle containing a peroxide-sensitive component (such as an enzyme; e.g., a hydrolase) and an added catalase component. The particle can be included in a detergent composition with peroxygen bleach.

### RELATED APPLICATIONS

This application is a continuation-in-part of U.S. Provisional Application Nos. 60/243,889 and 60/257,069, both of which are pending and are incorporated herein in their entirety.

### FIELD OF THE INVENTION

The present invention relates to particles, such as granules, containing a peroxide-sensitive component, such as an enzyme, e.g., a hydrolase. More particularly, the present invention relates to such a granule wherein the peroxide-sensitive component is protected.

### BACKGROUND

Increasingly, powdered laundry detergents are being formulated to include peroxygen bleaches, such as sodium perborate and sodium percarbonate, which, together with bleach activators, such as TAED and NOBS, act to generate hydrogen peroxide in situ, upon addition to the wash water within a clothes or dish washing machine. The peroxide thereupon acts to bleach or lighten certain stains, including protein-based stains, without significant damage to fabrics, and is therefore a preferred type of bleaching over other bleaching agents such as hypochlorite, which can cause fabric damage, especially after repeated use. Hydrogen peroxide is notoriously difficult to stabilize and peroxygen compounds such as perborates and percarbonates provide a dry, stable precursor form suitable for inclusion in dish and laundry detergents.

Enzymes also provide a cleaning benefit, which is in many cases complementary to, or synergistic with, the benefit provided by peroxygen bleaches, so detergent manufacturers like to include both enzymes and peroxygen bleaches in the same detergent. Unfortunately, peroxygen-bleach containing detergents, especially at elevated humidity levels, provide an inhospitable environment for enzymes, even when the enzymes are in a dry, granulated, or encapsulated form. In the presence of even relatively low levels of moisture, and at moderate or high temperatures, low but significant levels of hydrogen peroxide, peracids, or related species are generated and mobilized during storage of the detergent. These species are mobilized at a level sufficient to diffuse or penetrate into the dry enzyme particles and cause oxidative damage to the enzymes. Hydrogen peroxide damages enzymes primarily by means of oxidizing the methionine residues in the protein. A resulting loss of activity of the enzyme can occur especially, but not exclusively, when the methionine is located within or close to the active site of the enzyme molecule.

It is difficult to find coatings or encapsulating agents which provide an adequate barrier against the diffusion of peroxide and other small oxidants towards the interior of an enzyme granule or particle, which are at the same time sufficiently soluble or compatible with the laundry and dish detergent applications, to allow complete and rapid release of enzyme into the wash water upon dilution. Many antioxidant compounds, such as ascorbic acid, also have limited capacity to neutralize the peroxide and other such oxidants.

In addition to providing an adequate barrier to protect enzymes, desirable washing compounds must contain enzyme granules formulated to allow peroxygen bleach components to perform as expected. A well-known problem in the industry with peroxygen bleaches is their loss of activity in the presence of certain substances found in soiled clothing or on dishes. Catalase and other hydrogen peroxide oxido-reductase enzymes and donor:hydrogen peroxide oxido-reductases such as peroxidases, present on dishes and soiled clothing, decrease the performance of the bleach component by converting hydrogen peroxide into water. In fact, a variety of methods exist to inactivate catalase and other hydrogen peroxide oxido-reductase enzymes.

Peroxidases have been mentioned as additives to detergents, for example by addition to the detergent in the form of granules. For example, U.S. Pat. No. 5,855,621 mentions the use of peroxidases as dye transfer inhibitors, since they act to oxidize certain dyes present in clothes laundry via the counterbalanced reduction of hydrogen peroxide to donate oxygen to the dye substrate. Peroxidases require the presence of the applicable donor substrate to act upon hydrogen peroxide.

Catalases are found within the cells of a wide variety of animal, plant, bacterial, and fungal organisms, where they protect the cells from oxidative damage from the environment during the natural processes of metabolism and aging. Commercially, catalase is produced and isolated from animal liver, bacterial, and fungal sources. The most economical production comes from the large-scale fermentation of various bacterial and fungal cultures. The primary industrial uses of catalase are in combination with glucose oxidase to prevent the oxidative deterioration of food, to remove traces of hydrogen peroxide after it has been used to cold sterilize milk or cheese and as a scavenger for hydrogen peroxide in the tanning of textiles such as leather.

While a need exists in the industry for enzyme particles protected against bleaching components, it would be surprising for such protection to be provided by oxido-reductase enzymes without decreasing performance of the bleaching agents. Nowhere in the prior art or literature has it been contemplated to use substances that degrade hydrogen peroxide to protect industrial enzymes from oxidative losses during storage in laundry and dish detergents that contain peroxide-sensitive components.

### SUMMARY OF THE INVENTION

The present invention provides a particle containing a peroxide-sensitive component (such as an enzyme) and an ingredient that degrades hydrogen peroxide, such as catalase or other oxido-reductases. The particle can be included in a detergent composition with peroxygen bleach wherein the ingredient protects the peroxide-sensitive component and does not substantially affect the activity of the peroxygen bleach.

Even though the primary use intended by this invention is the protection of enzyme particles in dry laundry detergents, the invention logically extends to, and contemplates, the protection of any peroxide-sensitive ingredient used in laundry and dish detergents from inactivation by peroxide-generating compounds such as peroxygen-bleaches. For example, certain dyes and pigments are known to be sensitive to bleaches such as hydrogen peroxide, and dyes and pigments are commonly used in laundry detergents either to mask and alter the color of active ingredients, or to serve as a visual indicator to the detergent consumer, associating the claim of some cleaning benefit with a readily recognizable colored particle, one which stands out against the typically white background of the base detergent powder.

In one embodiment of the invention the particle includes an engineered or naturally occurring oxido-reductase which protects a peroxide-sensitive protein component of the particle.

In another embodiment of the invention the particle is a granule with a catalase component provided to protect a peroxide-sensitive enzyme component.

In one other embodiment of the invention catalase is added to a particle to protect a peroxide-sensitive dye or pigment component.

In the above embodiments of the invention the particle is formed by mixing catalase with the peroxide-sensitive component, or by coating catalase over the peroxide-sensitive component.

In yet one more embodiment a detergent with a bleaching agent includes a particle with a catalase and a peroxide-sensitive component.

The embodiments described above utilize an oxido-reductase enzyme, such as catalase in concentrations less than about 5,000 U/g of particle, generally between about 10-350 U/g of particle, and more particularly above about 20 U/g of particle. In one preferred embodiment utilizing a catalase derived from Aspergillus niger bacteria, the preferred concentrations are between about 10-200 U/g of particle, more preferably between about 15-150 U/g of particle; and most preferably between about 20-100 U/g of particle. Another preferred embodiment utilizes a catalase derived from Micrococcus bacteria, preferably at concentration of about 40-350 U/g of particle, more preferably about 50-250 U/g per gram of particle, and most preferably about 60-100 U/g of particle. The units (BU/g) or (U/g) used throughout are Baker Units, and 1 Baker Unit is defined as that amount of catalase which will decompose 264 mg hydrogen peroxide under the conditions of the assay described below in Example 4.

In a preferred embodiment, the particles include a peroxide-sensitive hydrolase enzyme or dye and are an ingredient of a detergent having peroxygen bleach, such as perborate or percarbonate; and the oxido-reductase is catalase derived from Aspergillus niger or Micrococcus species.

### BRIEF DESCRIPTION OF THE DRAWINGS

FIG. 1 is a graph demonstrating that catalase increases the accelerated storage stability of enzyme granules in powdered detergents containing bleaching agents.

FIG. 2 is a graph showing the effect of storage stability in such detergents relative to the amount of added catalase.

FIG. 2A is a graph showing the effect of storage stability in such detergents relative to a range of 0-50 U/g of added catalase.

FIG. 2B is a graph showing the effect of storage stability in such detergents relative to a range of 0 to about 800 U/g of added catalase derived from a Microccocus bacterium.

FIG. 3 is a graph showing the effect on storage stability in such detergents relative to the location within the particle of the added catalase.

FIG. 4A is a graph showing measured active oxygen levels at room temperature of powdered detergents having enzyme granules with and without added catalase and having bleaching agents.

FIG. 4B is a graph showing measured active oxygen levels at 40° C. of powdered detergents having granules with and without added catalase and having bleaching agents.

### DESCRIPTION OF THE INVENTION

Surprisingly, it has been found that an oxido-reductase, such as catalase enzyme, when included in a particle or granule having a peroxide-sensitive enzyme, even at relatively low concentrations, provides excellent protection of the peroxide-sensitive enzyme during storage against deactivation by hydrogen peroxide which is generated by the decomposition of peroxygen bleaches, while not significantly impairing the cleaning efficacy of those bleaches.

There are two important considerations that argue against such a use of catalase in peroxygen bleach containing detergents. First, human catalase is present in the skin and, as stated above, is a common component of soiled clothing. Detergent makers are aware of this, together with the fact that higher levels of catalase in soiled clothing and on dishes can consume peroxide and thereby reduce the bleaching efficacy of peroxygen bleaches. This consideration creates a presumption against incorporating catalase into laundry detergents, particularly those detergents having bleaching components, and without empirical proof to the contrary, one of skill in the art would not choose to do so. Second, and from the opposite direction, it would appear on the face of it that there is no way to add enough catalase to protect enzymes, dyes or other oxidatively sensitive active ingredients from the overwhelming amount of peroxygen bleach added to such bleach-containing clothing and dish detergents. That is, one would think that there would not be enough catalase in a typical box of detergent to effectively neutralize all the hydrogen peroxide which could be generated by the perborate or percarbonate. Thus, if one of skill in the art were to have considered adding catalase to a granule to protect other active ingredients therein from other ingredients used to make up a detergent, they would think it necessary to add a large quantity of catalase to the granules in order to achieve such goal (e.g., perhaps 5000 U catalase or more per gram of granule based on the amount of bleaching component in the detergent).

In short, based on the fact that human catalase, as from soiled clothing or dishes, in a typical wash cycle is known to deactivate bleach by destroying hydrogen peroxide, it was not expected that catalase could be formulated with a cleaning enzyme (like hydrolase) and achieve the goal of stabilizing the enzyme against oxidation during storage while still allowing the bleach to function effectively (i.e. not deactivating the bleach to a large percent) during a typical bleaching cycle (e.g., about 15 minutes).

Surprisingly, it has been found that relatively small amounts of catalase, if compartmentalized and concentrated within a granule, as opposed to dispersed homogeneously throughout a detergent, together with an enzyme or other peroxide-sensitive active ingredient, sufficiently protected the enzyme or other active ingredient from the action of hydrogen peroxide during storage, and that the enzyme or active ingredient can survive substantially intact, despite the vast excess of peroxygen bleach in the detergent, even under conditions of high temperature and humidity. Without wishing to be bound be any particular theory, apparently the amount of peroxide released and in a mobile form is not sufficient to significantly neutralize the catalase, or is not generated at a sufficient rate to outstrip the kinetics of the locally concentrated catalase in protecting the active ingredient. At the same time, it has been found that the level of catalase sufficient to protect the enzyme from activity loss during storage is insufficient to significantly impair the action of the peroxygen bleach when released and diluted during the actual wash cycle, when used in typical peroxygen bleach detergents, under typical use conditions.

In short, one skilled in the art would expect that the amount of catalase required to protect active ingredients such as enzymes against inactivation by hydrogen peroxide would be likely to counteract the benefit of that hydrogen peroxide during actual application in laundry or dish cleaning. Accordingly, one skilled in the art setting out to find a means of protecting granulated enzymes stored in detergent against inactivation by peroxygen bleaches would have no reasonable expectation of success by turning to catalase as a protecting agent. Yet, surprisingly, it turns out that granules can be made using a reasonable range of catalase concentrations, which concentrations of catalase protect the active ingredient during storage against inactivation by diffusing peroxide, while simultaneously having negligible effect on the final solution peroxide level or bleaching effect once the total detergent is dissolved in the wash application.

Within the family of enzymes known as oxido-reductases, catalases are defined as hydrogen-peroxide:hydrogen-peroxide-reductases, meaning that H₂O₂ is both reduced to H₂O and oxidized to O₂, according to the reaction equation:

2H₂O₂+Catalase [symbol] 2H₂O+O₂+Catalase (1)

For this reaction, an International Unit of catalase (IU) is defined as the amount of enzyme causing the decomposition of one micromole of hydrogen peroxide per minute at 25° C. and pH 7.0. The other major class of oxido-reductases is peroxidases, sometimes confused with catalases. Peroxidases are donor:hydrogen peroxide oxido-reductases, i.e., a donor substrate is oxidized, while the H₂O₂ is reduced to H₂O, according to the equation:

2H₂O₂+Donor Substrate+Peroxidase [symbol] 2H₂O+Oxidized Donor Substrate+Peroxidase (2)

A unit of peroxidase activity is defined as the amount of enzyme that catalyzes the conversion of one micromole of peroxide per minute at 25° C. and pH 7.0 (Guaicol as donor/substrate). Thus, a key difference between catalases and peroxidases is that catalases will spontaneously act to neutralize hydrogen peroxide whenever the two are brought into contact, where as peroxidases have no effect on hydrogen peroxide in the absence of the required donor substrate. A peroxidase, then, would not normally serve the purpose of this invention, since it would not protect the enzyme or active ingredient from the peroxide unless the donor or “activator” is simultaneously and intimately present, such as when the peroxide contacts the clothes dye during a laundry-washing step. The peroxide-sensitive enzyme or active ingredient needs to be protected during its long storage in the detergent box, when no clothes or dye are present.

Through experimental testing, it has been found that catalase levels less than about 5000 U per gram of particle are sufficient to provide a significant stability benefit against the action of peroxygen bleaches under normal formulation and storage conditions. In one embodiment of the present invention, the catalase is present at a concentration of less than about 5,000 U, generally between about 10-350 U/g of particle, and particularly above about 20 U/g of particle. In one preferred embodiment utilizing catalase derived from Aspergillus niger bacteria, the preferred concentration of catalase is from about 10 U/g of particle to about 200 U/g of particle, more preferably from about 15 U to about 150 U/per gram of particle, and most preferably from about 20 U to 100 U/g of particle.

Any suitable catalase can be utilized in practicing the present invention. As mentioned above, these ubiquitous enzymes have been purified from a variety of animal tissues, plants and microorganisms (Chance and Maehly 1955 Methods Enzymol. 2: 764-791; Jones and Wilson 1978 in H. Sigel (ed.), Metal Ions in Biological Systems, Vol. 7, Marcel Dekker Inc., New York). In one embodiment, the catalase is derived or obtained from a fungus, such as A. niger (See, e.g., U.S. Pat. No. 5,360,732) or an animal such as a cow (e.g. bovine catalase); in another embodiment the catalase is a non-naturally occurring (e.g., an engineered) catalase; in yet another embodiment the catalase is derived or obtained from a Micrococcus strain of bacteria; and in a further embodiment the catalase is derived from a different microorganism than the peroxide-sensitive ingredient to be protected.

The present invention also relates to cleaning compositions containing the granules of the invention. The catalase and hydrolase enzyme may form the core of a granule or may be coated over a core particle. The core particles suitable for use in the cleaning compositions of the present invention are preferably of a highly hydratable material, i.e., a material which is readily dispersible or soluble in water. Clays (bentonite, kaolin), nonpareils and agglomerated potato starch are considered dispersible. Nonpareils may be used and are typically made from a combination of a sugar, such as sucrose, and a powder, such as corn starch. Alternate seed crystal materials include sodium chloride and other inorganic salts.

Particles composed of inorganic salts and/or sugars and/or small organic molecules also may be used as the cores of the present invention. Suitable water soluble ingredients for incorporation into cores include: sodium chloride, ammonium sulfate, sodium sulfate, urea, citric acid, sucrose, lactose and the like. Water soluble ingredients can be combined with water dispersible ingredients. Cores can be fabricated by a variety of granulation techniques including: crystallization, precipitation, pan-coating, fluid-bed coating, rotary atomization, extrusion, spheronization and high-shear agglomeration.

The cores of the present invention may further comprise one or more of the following: fillers, plasticizers or fibrous materials. Suitable fillers useful in cores of the present invention include inert materials used to add bulk and reduce cost, or used for the purpose of adjusting the intended enzyme activity in the finished granulate. Examples of such fillers include, but are not limited to, water soluble agents such as urea, salts, sugars and water dispersible agents such as clays, talc, silicates, carboxymethyl cellulose or starches.

Suitable plasticizers useful in the cores of the present invention are nonvolatile solvents, typically low molecular weight organic compounds. Examples include, but are not limited to, polyols (polyhydric alcohols, for example, alcohols with many hydroxyl radical groups such as glycerol, ethylene glycol, propylene glycol or polyethylene glycol), polar low molecular weight organic compounds such as urea, or other known plasticizers such as dibutyl or dimethyl phthalate, or water.

Suitable fibrous materials useful in the cores of the present invention include: cellulose, glass fibers, metal fibers, rubber fibers, azlon (manufactured from naturally occurring proteins in corn, peanuts and milk) and synthetic polymer fibers. Synthetics include Rayon.RTM., Nylon.RTM., acrylic, polyester, olefin, Saran.RTM., Spandex.RTM. and Vinal.RTM.

In a granule embodiment of the present invention, the core is a water soluble or dispersible nonpareil or sugar crystal which may be either coated by PVA either alone or in combination with anti-agglomeration agents such as titanium dioxide, talc, or plasticizers such as sucrose or polyols. The PVA may be partially hydrolyzed PVA, intermediately hydrolyzed PVA, fully hydrolyzed PVA, or a mixture thereof, with a low to high degree of viscosity. Preferably, the core is coated with partially hydrolyzed PVA, either alone or in combination with sucrose or such other plasticizer as known in the art. Partially hydrolyzed PVA is preferred because it results in a lower amount of residue upon dissolution of the granule than fully hydrolyzed PVA.

Any enzyme or combination of enzymes may be used in the present invention. Preferred enzymes include those enzymes capable of hydrolyzing substrates, e.g., stains. These enzymes are known as hydrolases, which include, but are not limited to, proteases (bacterial, fungal, acid, neutral or alkaline), amylases (alpha or beta), lipases, cellulases, and mixtures thereof. Particularly preferred enzymes are subtilisins and cellulases. Most preferred are subtilisins such as described in U.S. Pat. Nos. 4,760,025 and 5,185,258 which are incorporated herein by reference, and cellulases or cellulase components isolated from Trichoderma reesei such as Cellulase 123.TM. and Multifect.TM. L250, commercially available from Genencor International, or mixtures thereof or those described in commonly owned U.S. application Ser. No. 07/770,049 incorporated herein by reference. The enzyme layer of the present invention may contain, in addition to the enzyme per se and the added catalase, a vinyl polymer and preferably PVA.

The enzyme layer may also further comprise plasticizers and anti-agglomeration agents. Suitable plasticizers useful in the present invention include polyols such as sugars, sugar alcohols or polyethylene glycols (PEGs), ureas or other known plasticizers such as dibutyl or dimethyl phthalate, or water. Suitable anti-agglomeration agents include fine insoluble material such as talc, TiO₂, clays and amorphous silica.

The granules of the present invention may comprise one or more coating layers. For example, such coating layers may be one or more intermediate coating layers, or such coating layers may be one or more outside coating layers, or a combination thereof. The outer coating layer may comprise a vinyl polymer or copolymer, preferably PVA, and optionally a low residue pigment or other excipients such as lubricants. Such excipients are known to those skilled in the art. Furthermore, coating agents may be used in conjunction with other active agents of the same or different categories. Other vinyl polymers which may be useful include polyvinyl acetate and polyvinyl pyrrolidone. Useful copolymers include, for example, PVA-methylmethacrylate copolymer.

The coating layers of the present invention may further comprise one or more of the following: plasticizers, pigments, lubricants such as surfactants or antistatic agents and, optionally, additional enzymes. Suitable plasticizers useful in the coating layers of the present invention are plasticizers including, for example, polyols such as sugars, sugar alcohols or polyethylene glycols (PEGs) having a molecular weight less than 1000, ureas or other known plasticizers such as dibutyl or dimethyl phthalate, or water. Suitable pigments useful in the coating layers of the present invention include, but are not limited to, finely divided whiteners such as titanium dioxide or calcium carbonate, or colored pigments, or a combination thereof. Preferably such pigments are low residue pigments upon dissolution.

Suitable lubricating agents include, but are not limited to, surfactants (ionic, nonionic or anionic), fatty acids, antistatic agents and antidust agents, and Neodol.RTM product line from Shell International Petroleum Company. Other suitable lubricants include, but are not limited to, antistatic agents such as StaticGuard.TM., Downey.TM., Triton X100 or 120 and the like, antidust agents such as Teflon.TM. and the like, or other lubricants known to those skilled in the art.

Adjunct ingredients may be added to the enzyme granules of the present invention. Adjunct ingredients may include: metallic salts, solubilizers, activators, antioxidants, dyes, inhibitors, binders, fragrances, enzyme protecting agents/scavengers such as ammonium sulfate, ammonium citrate, urea, guanidine hydrochloride, guanidine carbonate, guanidine sulfonate, thiourea dioxide, monethyanolamine, diethanolamine, triethanolamine, amino acids such as glycine, sodium glutamate and the like, proteins such as bovine serum albumin, casein and the like, etc., surfactants, including anionic surfactants, ampholytic surfactants, nonionic surfactants, cationic surfactants and long-chain fatty acid salts, builders, alkalis or inorganic electrolytes, bleaching agents, bluing agents and fluorescent dyes, and caking inhibitors. These surfactants are all described in commonly assigned PCT Application PCT/U.S. No. 92/00384, which is incorporated herein by reference.

The granules described herein may be made by methods known to those skilled in the art of enzyme granulation, including fluidized bed spray-coating, pan-coating and other techniques for building up a granule by adding consecutive layers on top of a starting core material.

The teachings of the present invention can be readily adapted to any number of granule formulations, such as Enzoguard™ (See U.S. Pat. No. 5,324,649; Genencor International Inc., Rochester, N.Y.) or Savinase™ granules (Novo Nordisk, Denmark), among others. Other exemplary granule formulations which can incorporate the teachings herein include those disclosed in, U.S. Pat. Nos. 4,689,297, 5,814,501, WO 9712958, U.S. Pat. No. 4,106,991, WO 99/32613, PCT application no. US 00/27888, and those described in “Enzymes In Detergency,” ed. Jan H. van Ee, et al., Chpt. 15, pgs. 310-312 (Marcel Dekker, Inc., New York, N.Y. (1997)); all of which are expressly incorporated herein by reference.

In a preferred embodiment, the catalase is closely associated with the peroxide-sensitive ingredient; e.g., the fermentation broth of the catalase can be mixed or blended together with the fermentation broth or other fluid formulation of the sensitive ingredient, or it can be located directly adjacent the sensitive ingredient (e.g., layered over the sensitive ingredient). The invention is not limited, however, to such placement, and contemplates the incorporation of catalase at any location within the granule which permits the benefits described herein.

### EXAMPLES

The following examples are representative and not intended to be limiting.

### Example 1

Catalase-Containing Protease Granules (100 U/g of Catalase).

An exemplary formulation for a batch of granules, produced using a fluid-bed spray process, is shown below in Table I. The initial spray in this example was applied to 539.0 gms of sucrose crystals charged into a fluid-bed chamber, and suspended therein. The enzyme used was Purafect™ (Genencor International, Inc.). “Spray 1 ” denotes an enzyme matrix formed on a fluidizable particle, “spray 2” denotes a barrier matrix, and “spray 3” denotes a clear polymer film coating. The catalase used was derived from Aspergillus niger and the fermentation broth was mixed with the fermentation broth of the Purafect proteolytic enzyme. The resulting mixture was then blended together with the sucrose and starch components of spray 1. Certain details of the fluid-bed process were substantially as described in Example 2 of WO 99/32613, incorporated herein by reference. Except for the inclusion of catalase, the granule is generally like that described in PCT application no. US 00/27888, incorporated herein by reference.

TABLE I

| | | |
|---|---|---|
| SPRAY 1: | Purafect conc. | 1419 ml |
| | (19.3% solids) | |
| | Catalase conc. | 42 ml |
| | (6.0% solids, 5,300 IU/ml) | |
| | Sucrose | 179.5 gms |
| | Starch | 538.5 gms |
| SPRAY 2: | Corn starch | 224.4 gms |
| | Sucrose | 224.4 gms |
| | TiO2 | 134.2 gms |
| | Neodol | 28.6 gms |
| SPRAY 3: | HPMC (Methocel E15) | 51.3 gms |
| | PEG 600 | 3.6 gms |

### Example 2

Accelerated Stability Study.

As discussed in WO 99/32613 (incorporated herein by reference), the accelerated stability test (AST) is designed to aid in the development and screening of granular formulations, as it provides an accelerated means of determining relative granule stability. The conditions of the AST are generally far more severe than enzyme granules or detergents would encounter in realistic storage or transport. The AST is a “stress test” designed to discriminate differences between formulations, which would otherwise not be evident for weeks or months.

The present accelerated stability study was carried out using 30 mg of protease granules mixed with 1 gram of detergent base containing between 12 and 14% by weight of a peroxygen bleach (sodium perborate tetrahydrate). The sample then was exposed to a high humidity and high temperature environment for a certain number of days in order to simulate extended storage at room temperature.

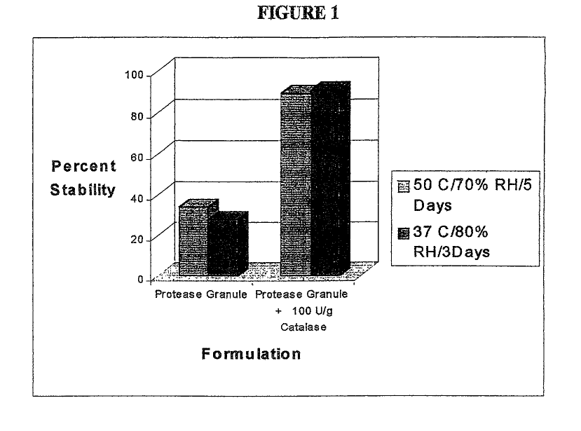

In FIG. 1, the effects of adding a relatively small amount of catalase, in this case about 100 U/g, into the enzyme layer of a model protease granule are shown in two different accelerated storage stability conditions. It can be clearly seen that the addition of catalase into the protease granule has greatly enhanced its accelerated storage stability under both accelerated conditions as compared to the protease granule without added catalase.

### Example 3

Effect of Catalase Dose Level in Protease Granules on Storage Stability.

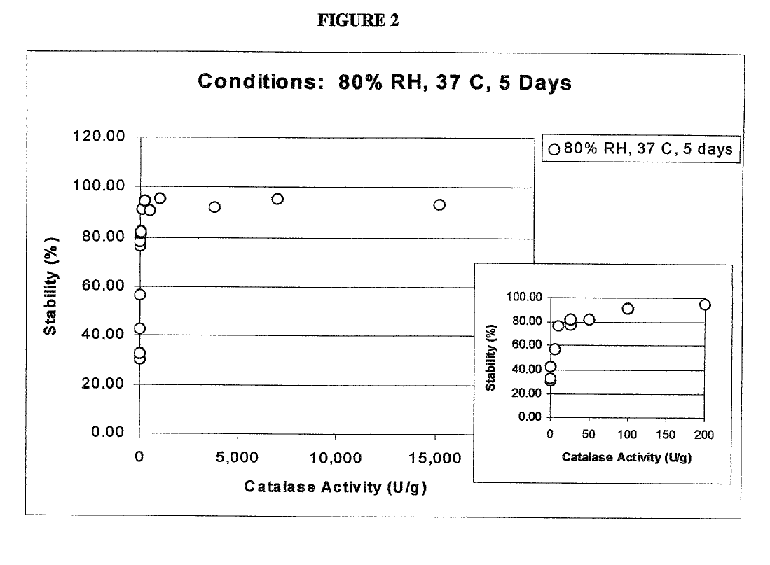

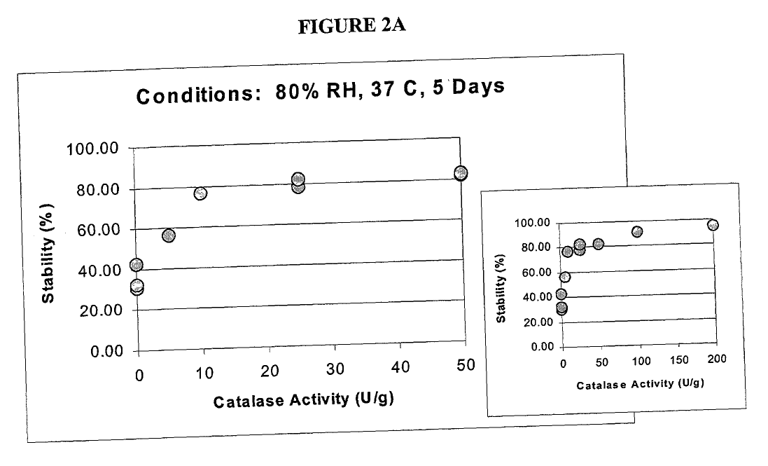

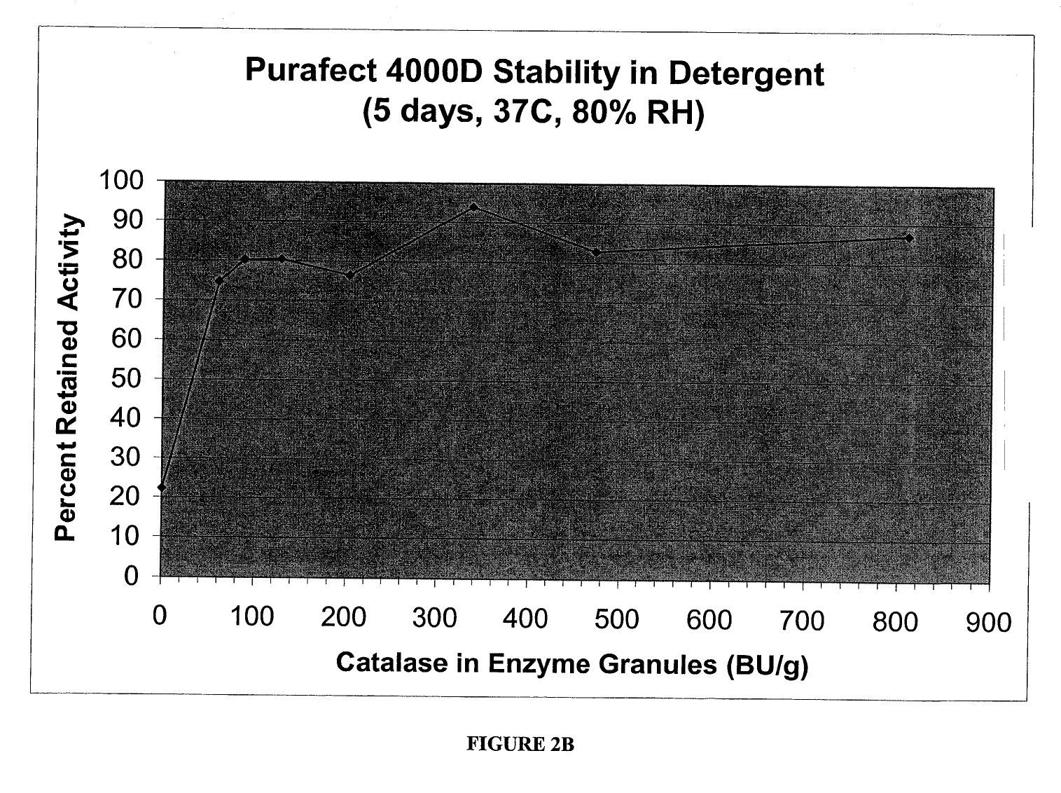

As can be ascertained from the data of FIG. 2, as the catalase dose is increased from 0 to about 200 U/g in the protease granule, the storage stability increases monotonically to a value of about 95%. Above a level of about 200 U/g of catalase, the protease granule shows no further improvement in storage stability. FIG. 2A illustrates the effect upon storage stability using catalase dosages of 0 to 50 U/g. Satisfactory stability percentages of approximately 80% are reached with as little as approximately 10 U/g of catalase.

FIGS. 2 and 2A illustrate the use of added catalase derived from Aspergillus niger. FIG. 2B illustrates catalase dosage effects utilizing a catalase derived from Micrococcus bacteria. The catalase was added to an enzyme based granule and storage stability was measured after 5 days. The data in FIG. 2B demonstrates that storage stability increases monotonically up to a value of about 75% at approximately 60 BU/g of added catalase. Stability remains between about 75% to 80% at catalase levels between about 60-210 BU/g. The stability was about 95% at 310 BU/g, and thereafter with additional catalase up to about 800 BU/g, stability remained between about 95% to about 88%. This data supports the FIG. 2 and 2A data by demonstrating that as little as about 10 U/g of particle of added catalase does provide some protective effect to the proteolytic enzyme to be protected.

### Example 4

Endogenous Catalase Test

Three commercially available detergent compounds having subtilisin or protease enzymes (Purafect, Genencor International, Inc.; Savinase, NovoZymes; and Properase, Genencor International, Inc.) were analyzed at pH 7.0 and pH 5.8 to determine whether they contained any endogenous catalase, as opposed to deliberately added catalase. Two lot numbers of Properase and two different Properase formulations also were tested as above using the Baker catalase assay which is based on the simultaneous inactivation of catalase by hydrogen peroxide and the breakdown of hydrogen peroxide by catalase. Residual hydrogen peroxide was analyzed in the reaction mixture after 60 min incubation with catalase at 25° C. One Baker Unit is defined as that amount of catalase which will decompose 264 mg hydrogen peroxide under the conditions of the assay. Within the industry, Sigma Units may also be used, and one Baker Unit is equal to approximately 40 Sigma Units.

The solutions used in the assay included a 0.2 M sodium phosphate buffer, a buffered substrate solution (450 ml of deionized water mixed with 500 ml of 0.2 M sodium phosphate buffer with 44-46 ml of 30% hydrogen peroxide), 40% (w/v) potassium iodide solution, and a 1% (w/v) ammonium molybdate solution.

The Baker assay was performed by first testing the initial concentration of hydrogen peroxide in the buffered substrate. Buffered substrate and 40% potassium iodide were added to sulphuric acid. Ammonium molybdate was added to the mixture which was titrated with 0.25 M thiosulphate to insure that a titration volume of 14-16 ml is obtained. The catalase in the enzyme sample was tested using the following procedure:

1. Dispense 50 ml aliquots of buffered substrate into suitable, lightly stoppered test tubes or flasks and pre-incubate at 25° C. for 15 min;

2. Add 200 ml of catalase solution (diluted in 0.2M phosphate buffer to between 5-9 Baker Units/ml);

3. Mix thoroughly and incubate at 25° C. for 60 min. Shake occasionally to liberate the oxygen from reaction mixture;

4. At the end of the incubation period shake the reaction mixture until all oxygen has been removed;

5. Pipette 4.0 ml of reaction mixture into the sulphuric acid and add 5 ml of 40% potassium iodide solution;

6. Add two drops of ammonium molybdate and titrate with 0.25 M thiosulphate

The titration end point is reached when free iodine color disappears.

Catalase activity (U/ml)=(B−S)×DF

Where

B is the titration volume of the substrate blank (average of 3) (ml)

S is the titration volume of the sample (ml)

DF is the dilution factor of sample

The results are shown in Table II below.

| Material | Lot # | PH | Catalase Activity (U/g) |
|---|---|---|---|
| Purafect 6900M | 102-120-001388 | 7.0 | 0.00 |
| Purafect 6900M | 102-120-001388 | 5.8 | 0.20 |
| Savinase 6.0T | (w) 6/20/97 | 7.0 | 0.50 |
| Savinase | (W) 6/20/97 | 5.8 | 0.00 |
| Properase 4000D | 302-00144-001 | 7.0 | 2.59 |
| Properase 4000D | 302-00144-001 | 5.8 | 5.18 |
| | | | 3.67 |
| | | | 4.19 |
| Properase 4000D | 302-00137-001 | 7.0 | 3.63 |
| Properase 4000D | 302-00137-001 | 5.8 | 3.63 |
| | | | 3.62 |
| | | | 4.14 |
| Properase 1000D | 102-30-00121 | 7.0 | 1.52 |
| Properase 1000D | 102-30-00121 | 5.8 | 2.29 |
| Properase 4000D | 302-00138-001 | 5.8 | 0.00 |
| | | | 0.58 |

The results of Table II are accurate to +/−2 U/g, and suggest that endogenous catalase, if present in commercial formulations, is at a level of less than 7 U/g. Such levels do not provide acceptable stability levels as illustrated in FIG. 2A which shows that a level of approximately about 10 U/g of catalase is needed to provide approximately 80% stability. The results further suggest, when endogenous catalase is present in commercial detergents, the amount is inconsistent and cannot be relied upon to protect the active enzyme ingredient from deactivation by hydrogen peroxide.

### Example 5

Effect of Location of Catalase in the Granule.

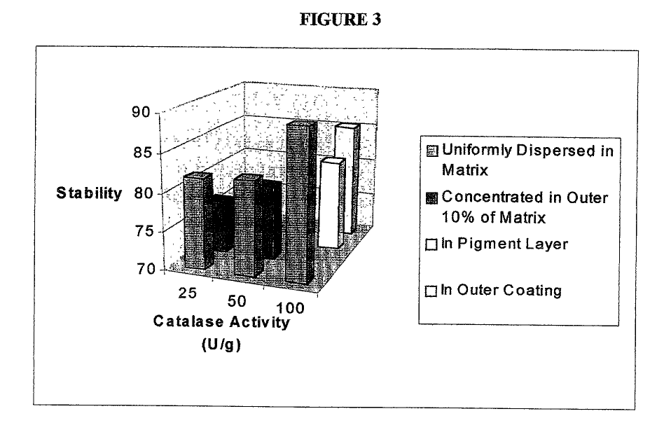

The data of FIG. 3 indicate that a preferred location for the catalase is uniformly dispersed with the protease enzyme. If catalase is concentrated in the outer portion of the enzyme layer, or put into a separate layer altogether, a slight decrease in oxidative storage stability is observed. The preferred location places the catalase in intimate contact with the enzyme to be protected. Intimate contact is achieved by mixing the enzymes together, such as by blending fermentation broths.

### Example 6

Effect of Added Catalase on Perborate Activity

The catalase containing particles were tested to determine whether the presence of the catalase adversely affects sodium perborate or percarbonate bleaching components. As discussed above, catalase in soiled clothing is known to consume peroxide and reduce bleaching efficacy. The amount of bleaching component was determined by measuring the amount of available, active oxygen. When dissolved in water, perborates and percarbonates dissociate into sodium metaborate, hydrogen peroxide and water as shown in the following reaction:

(NaBO₂H₂O₂)₂·xH₂O→2NaBO₂+2H₂O+xH₂O

The quantity of hydrogen peroxide is titrated using potassium permangate as follows:

5H₂O₂+2KMnO₄+3H₂SO₄→2MnSO₄+K₂SO₄+8H₂O

The percent active oxygen is calculated Using the following formula:

% active oxygen={(V−B)·N·A×0.008/W}·100

Where:

V=milliliters of KMnO₄ solution required for titration of the sample

B=milliliters of KMnO₄ solution required for titration of a blank

N=normality of the KMnO₄ solution

A=aliquot factor

W=grams of sample used

If desired, the determined active oxygen amount may be converted to determine the percent of peroxide producing compound present by multiplying the active oxygen by the appropriate conversion factor for the particular form of peroxide producing compound in the sample.

As shown in wash performance tests illustrated in FIGS. 5A and 5B, active oxygen levels were determined for six samples at 25° C. and three samples at 40° C.

The samples tested at room temperature included a detergent with conventional Properase 4000D particles (expected to contain between 2.59 and 5.18 U/g±2 of endogenous catalase activity per Table II), a detergent with Purafect 4000D granules with 50 U/g of added catalase, a detergent with Purafect 4000D granules with 100 U/g of added catalase, a detergent and fabric sample with catalase containing stains, and an active oxygen control sample (enzyme-free commercially available detergent with a bleaching agent).

The samples tested at 40° C. were the detergent with Purafect 4000D granules with 50 U/g of added catalase, a detergent with Purafect granules (expected to contain 0.00 to 0.02 endogenous catalase per Table II), and the enzyme-free detergent with bleaching agent control.

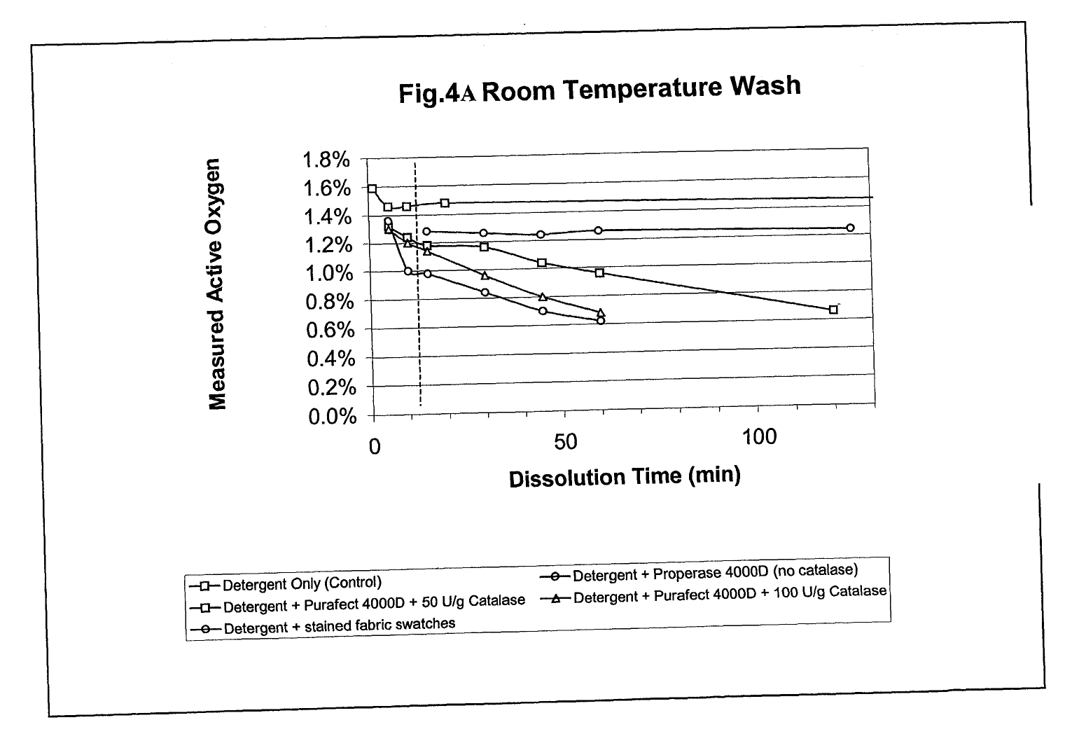

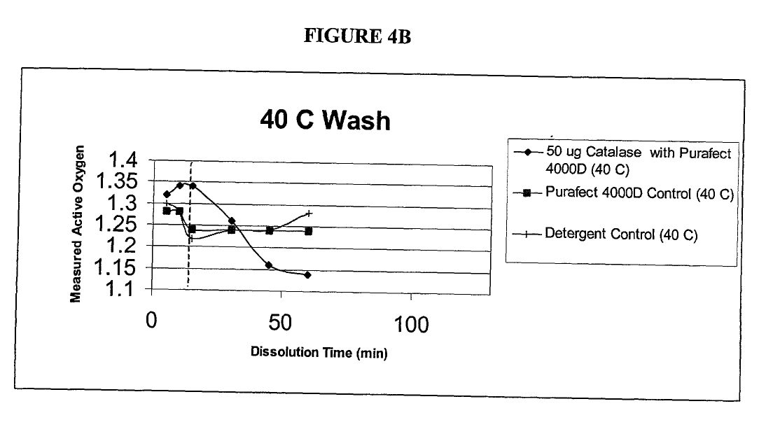

The data shown in FIGS. 4A and 4B show that granules with added catalase of up to at least 100 U/g did not significantly reduce the active oxygen level after about 20 minutes as compared to the detergent/stained fabric sample and the conventional enzyme detergent sample. The amount of the reduction in active oxygen did not significantly interfere with the bleaching ability of the detergents, and in any event, the enzyme-free detergent/bleaching agent control demonstrates that active oxygen does decline slightly in any event, with or without catalase. Active oxygen levels also are further lowered in the presence of heat and high relative humidity (around 80% relative humidity). The detergent/stained fabric showed the most decline in active oxygen with the catalase in the stains rapidly consuming hydrogen peroxide. The two enzyme based detergent samples having added catalase resulting in only slightly less active oxygen than the enzyme containing detergent without added catalase at around 10 minutes, and the formulations with added catalase had the benefit of protection of the proteolytic enzyme component of the granule. The results show that significant amounts of catalase can be added, in this case up to at least about 100 U/g, without seriously affecting the bleaching abilities of the detergent for the duration of a normal wash cycle.

Various other examples and modifications of the foregoing description and examples will be apparent to a person skilled in the art after reading the disclosure without departing from the spirit and scope of the invention, and it is intended that all such examples or modifications be included within the scope of the appended claims. All publications and patents referenced herein are hereby incorporated by reference in their entirety.

1. A particle containing a peroxide-sensitive component and a hydrogen-peroxide:hydrogen-peroxide-reductase.

2. The granule of claim 1 wherein the peroxide-sensitive component is an enzyme, selected from a protease, an amylase, a cellulase, or a lipase.

3. The particle of claim 1 wherein the peroxide-sensitive component is a peptide.

4. The particle of claim 1 wherein the peroxide-sensitive component is a protein.

5. The particle of claim 1 wherein the peroxide-sensitive component is a dye or pigment.

6. The particle of claim 1 wherein the hydrogen-peroxide:hydrogen-peroxide-reductase is mixed together with the peroxide-sensitive component.

7. The particle of claim 1 wherein the hydrogen-peroxide:hydrogen-peroxide-reductase is coated over the peroxide-sensitive component.

8. The particle of claim 1 wherein the hydrogen-peroxide:hydrogen-peroxide-reductase is present at a concentration of less than about 5,000 U/g of particle.

9. The particle of claim 1 wherein the hydrogen-peroxide:hydrogen-peroxide-reductase is present at a concentration above 20 U/g of particle.

10. The particle of claim 1 wherein the hydrogen-peroxide-reductase is present at a concentration of about 10-350 U/g of particle.

11. The particle of claim 1 wherein the hydrogen-peroxide:hydrogen-peroxide-reductase is present at a concentration of about 10-200 U/ gram of particle.

12. The particle of claim 1 wherein the hydrogen-peroxide:hydrogen-peroxide-reductase is present at a concentration of about 15-150 U/g gram of particle.

13. The particle of claim 1 wherein the hydrogen-peroxide:hydrogen-peroxide-reductase is present at a concentration of about 20-100 U/gram of particle.

14. The particle of claim 1 wherein the hydrogen-peroxide:hydrogen-peroxide-reductase is present at a concentration of about 60-100 U/gram of particle.

15. The particle of claim 1 wherein the hydrogen-peroxide:hydrogen-peroxide-reductase is a naturally occurring catalase.

16. The particle of claim 1 wherein the hydrogen-peroxide:hydrogen-peroxide-reductase is an engineered catalase.

17. The particle of claim 1 wherein the hydrogen-peroxide:hydrogen-peroxide-reductase is a catalase derived from Aspergillus niger.

18. The particle of claim 1 wherein the hydrogen-peroxide:hydrogen-peroxide-reductase is a catalase derived from a Micrococcus species of bacteria.

19. A detergent with peroxygen bleach, such as perborate or percarbonate, including the particle of claim 1.

20. A method of stabilizing an enzyme in a detergent granule containing peroxygen bleach, the method comprising the step of adding a hydrogen-peroxide:hydrogen-peroxide-reductase to the enzyme during manufacture of the granule.

21. The method of claim 20 wherein the hydrogen-peroxide:hydrogen-peroxide-reductase is a catalase that is mixed together with the enzyme.

22. The method of claim 20 wherein the hydrogen-peroxide:hydrogen-peroxide-reductase is a catalase that is added to surround the enzyme.

23. The method of claim 20 wherein about 10-200 U of a catalase hydrogen-peroxide:hydrogen-peroxide-reductase is added per gram of the granule.

24. The method of claim 20 wherein about 15-150 U of a catalase hydrogen-peroxide:hydrogen-peroxide-reductase is added per gram of the granule.

25. The method of claim 20 wherein about 20-100 U of a catalase hydrogen-peroxide:hydrogen-peroxide-reductase is added per gram of the granule.

26. The method of claim 20 wherein about 60-100 U of a catalase hydrogen-peroxide:hydrogen-peroxide-reductase is added per gram of the granule.

27. The method of claim 20 wherein above 20 U of a catalase hydrogen-peroxide:hydrogen-peroxide-reductase is added per gram of the granule.
